(19) United States
(12) Patent Application Publication
(10) Pub. No.: US 2003/0225632 A1
(43) Pub. Date: Dec. 4, 2003

(54) Method and system for providing personalized online shopping service

(76) Inventors: Vincent Tong, Alameda, CA (US); Kamal Acharya, Los Altos, CA (US); Ellen F. Butler, San Francisco, CA (US); Praveen Shenoy, Santa Clara, CA (US); Kiersten Lammerding, Sunnyvale, CA (US)

Correspondence Address: GLENN PATENT GROUP, 3475 EDISON WAY, SUITE L, MENLO PARK, CA, 94025, US

(21) Appl. No.: 10/160,822

(22) Filed: May 30, 2002

(51) Int. Cl. G06F 17/60

(52) U.S. Cl. 705/27

(57) ABSTRACT

The method and system of the present invention provides instant personalized online shopping information and assistance for fast and filtered shopping experience that enables online shoppers to confidently and conveniently shop online, knowing that they are getting the best deal for a product or service. Online shoppers may access their own personalized shopping lists or personalized shopping list of other persons. The system and method of the present invention saves shopping time for selective and busy shoppers, attracts more physical product or service retail outlets to join online shopping services, and retains the existing online product or service providers.

### BACKGROUND OF THE INVENTION

### FIELD OF THE INVENTION

The invention relates to online shopping. More particularly, the invention relates to a system and a family of methods that provide a personalized, relevant, instant, and comprehensive online shopping service.

### DESCRIPTION OF RELATED TECHNOLOGY

Present online shopping service providers do not provide personalized and comprehensive online shopping information that is seamlessly connected to the Web pages of online shopping service providers. Currently, online shoppers cannot instantly view their desired products or services from their favorite providers, and do not receive online shopping information about special sales, advertisements, and popular products from such providers, when they sign onto an online shopping service provider's home page.

Current online shopping service providers do not allow online shoppers to search, view, and select an item from an online shopping list that relates to the shopper or another person, when the shopper is browsing the online shopping service provider's home page.

There is a need, therefore, for online shopping service providers that provide online shoppers with the ability to select their favorite shopping categories or providers for their desired products or services, to receive detailed and personalized shopping information about the specials and popular products or services offered by their favorite providers, and to search and view shopping lists that relates to themselves, to friends, or other members of their families. There is also a need for online shopping service providers that attract and retain more offline product or service providers by highlighting detailed information and features about them online.

### SUMMARY OF THE INVENTION

One presently preferred embodiment of the invention provides a system and a method for providing personalized online shopping information that may include providing personalized information about at least one favorite provider of an item for a shopper. The personalized shopping information may include information about the special-sale and popular items that are provided by the shopper's favorite provider. The personalized online shopping information may also include information about personalized shopping lists of favorite items, where the personalized shopping lists may include shopping lists related to the shopper and shopping lists related to persons other than the shopper.

Another presently preferred embodiment of the invention provides a system and a method for searching online shopping information that may include the steps of searching favorite shopping categories for a shopper, searching favorite providers of items in the favorite shopping categories, and providing information about the items provided by the favorite providers.

### BRIEF DESCRIPTION OF THE DRAWINGS

FIG. 1 shows a representation of an exemplary online shopping information page according to one embodiment of the present invention;

FIG. 2 shows a representation of an exemplary favorite providers information page;

FIG. 3 shows a representation of an exemplary shopping list information page;

FIG. 4 shows a representation of an exemplary search information page;

FIG. 5 shows a representation of an exemplary gift ideas and specialty shops information page;

FIG. 6 shows a representation of an exemplary quick checkout information page; and

FIG. 7 shows a representation of an exemplary system for providing personalized shopping information.

### DETAILED DESCRIPTION OF THE INVENTION

The invention contemplates a new and unique system and a family of methods for online shopping, which may be implemented in a network of computer systems, such as the Internet. A computer system may include user terminals, storage devices, processing units, input and output devices, and networking devices and software modules.

Online shoppers may include those shoppers who both search and purchase their products or services online, and those bargain-seeker shoppers who usually take the information they obtain from online search results to offline local providers, looking for special sales and/or coupons. Therefore, current online shopping service providers lose revenue unless they attract and retain more online shoppers by providing them personalized, instant, and comprehensive online shopping information. The information may preferably be provided when a shopper signs onto an online shopping service provider's Web page, and may be linked to the same Web page that the online shopping service provider provides for online shopping.

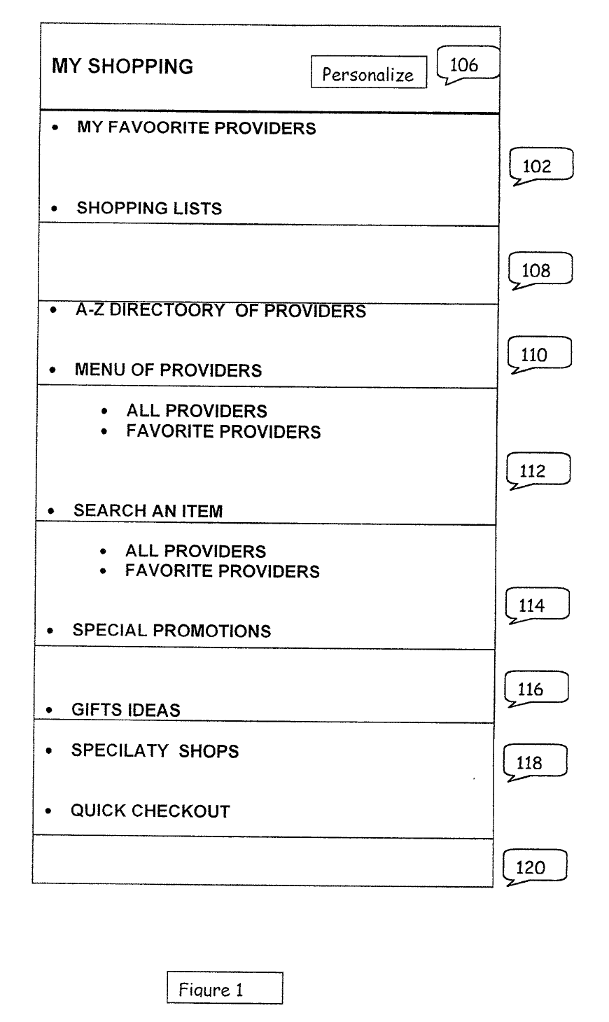

FIG. 1 shows a representation of an exemplary personalized online shopping information page that may be presented to a shopper according to one preferred embodiment of the invention. After the shopper signs onto an online shopping service provider's Web page, or when the shopper indicates that he is interested in online shopping, the personalized shopping information page may be instantly and automatically presented to the shopper. The personalized shopping information page may be seamlessly connected to the shopping service provider's Web page. If the shopper is revisiting his or her personalized shopping information page, items of shopping information as shown in FIG. 1, for example, may have been personalized for him. On the other hand, if the shopper is visiting the shopping information page for the first time, he may customize the shopping information page by activating the “Personalize” icon 106, as will be discussed below.

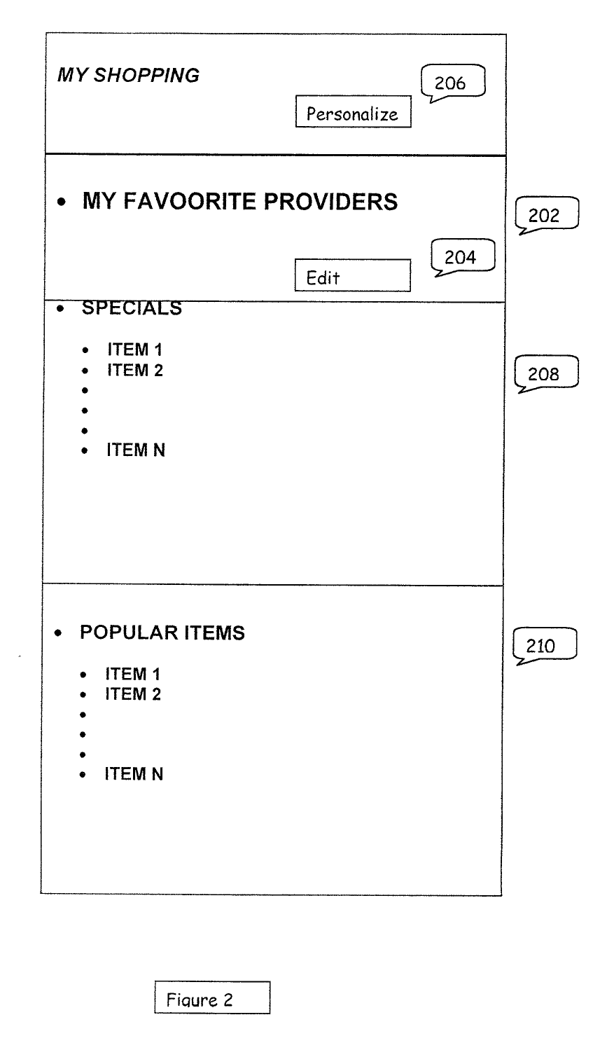

The shopping information item 102 may provide a link to a personalized shopping information page about the shopper's favorite or preferred providers of products or services, such as favorite department stores and specialty shops. When the shopper activates the shopping information item 102, the exemplary shopping information page “MY FAVORITE PROVIDERS,” as shown in FIG. 2, may be displayed. The shopper may edit this list by selecting the edit icon 204. After the shopper selects the edit icon 204, a directory of shopping categories of providers may be provided to the shopper. The directory may be an alphabetical directory of shopping categories such as “toys and games,” “electronics,” and “music and books.” After the shopper selects a favorite shopping category, e.g. “toys and games,” a list of providers for the selected shopping category may be provided to the shopper. The shopper may select a number of favorite providers, e.g. providers “A” and B,” that provide the selected shopping category, e.g. “toys and games.” The shopper may save the selected favorite providers. In one embodiment, the shopper may save the list of his or her selected favorite providers under “my favorite providers” shopping information item by selecting the “personalize” icon 206. Selecting icon 206 may cause the display of a menu, which may include “customize,” “remove,” and “help” menu items.

According to one embodiment of the invention, the shopping information page in FIG. 2 may include information about “specials” 208 and “popular products” 210, which may be provided by the shopper's favorite providers. The information item “specials” 208 may provide the list of products or services that are on special sale, and the “special products” information item 210 may provide the list of products and services that have recently hit the market. The information items “specials” and “popular products” may be programmed contents, meaning that they may be programmed and/or regularly updated, based on the input or request information received from the partner-providers.

In the present exemplary embodiment, the items under “toys and games” that are on special sale by the favorite providers “A” and “B” may be listed under “specials” for the shopper. The shopper may select an item from the list of specials and/or popular items. More information about the selected item may be provided, including a photo, price, description, one or more provider for the selected item, a direct link to the product page, and a direct link to one or more provider's Web page for the selected item. The shopper may select the direct link to a provider of the selected item to view the provider's Web page, which may provide information about the provider, information about other similar items along with their corresponding description, and price and availability of the selected item.

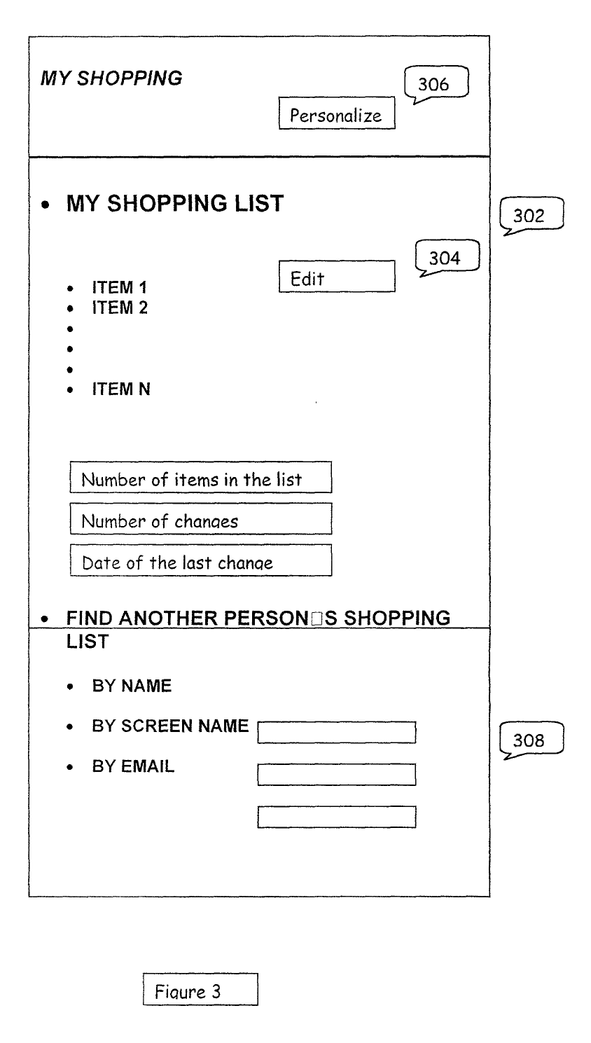

The shopping information item 108 may provide a link to a shopping information page about shopping lists of favorite or desired products or services, which may have been previously compiled by shoppers. When the shopper activates the shopping information item 108, the exemplary shopping list information page “MY SHOPPING LISTS,” as shown in FIG. 3, may be displayed. The shopping list information page may provide information about public and private forthcoming special occasions and the corresponding gift ideas. The shopping list information page may also provide an indication for recent changes to the shopping list, and/or the number of items currently on the shopping list. The shopping list information page in FIG. 3 may provide information about “my shopping list” 302 that relates to the shopper. The shopper may cause the display of his or her shopping list by selecting the “my shopping list” icon. The list may include information about the items in the list, including a photo, price, description, one or more provider for the selected item, the date an item was put on the list, a direct link to a product page, and a direct link to one or more provider for an item in the shopping list. The shopper may edit this list by selecting the edit icon 304

The shopper may select the direct link to a provider of a selected item in the shopping list to view the provider's Web page, which may show information about the provider, information about other similar items along with their corresponding description, and price and availability of the selected item. The shopper's shopping list may be removed from the list by selecting a “remove” icon. In one embodiment, the shopper may personalize his or her complied shopping list under “my shopping list” information by selecting the “Personalize” icon 306. Selecting the icon 306 may cause the display of a menu, which may include “customize,” “remove,” and “help” menu items.

The shopping list information page in FIG. 3 may also provide information about a shopping list that relates to a person other than the shopper. The shopper may access this shopping list by activating the “Find another person's shopping list” icon 308. Searching for another person's shopping list may be based on the person's name, screen name, or e-mail information. If the other person's shopping list is public, the shopper may access it and add it to his or her shopping list. If, however, the other person's shopping list is private, the shopper may request, e.g. via e-mail, the owner of the shopping list for access authorization and instruction. The other person may provide permission and access information to the shopper for accessing his or her private shopping list. The shopper may then search, view, and add the other person's shopping list to his shopping list, e.g. by selecting a “click-to-add” feature embedded in the email received from the other person.

The list may include information about the items in the list, including a photo, price, description, one or more provider for an item, the date an item was put on list, a direct link to an item's product page, and a direct link to one or more provider for a selected item in the shopping list. The shopper may select the direct link to a provider of a selected item to view a provider's Web page, which may show information about the provider, and information about other similar items along with their corresponding description, price, and availability. The shopper may choose an item from this list for purchasing it or including it into the shopper's shopping list, or remove it from the list by selecting a “remove” icon. In one embodiment, the shopper may personalize the complied shopping list under “my shopping list” information item by selecting the “personalize” icon 306. Selecting the icon 306 may cause the display of a menu, which may include “customize,” “remove,” and “help” menu items.

The shopping information item 110 may provide a shopping information page about a directory of providers of products or services. When the shopper activates the shopping information item 110, a shopping directory information page “A-Z DIRECTORY OF PROVIDERS” may be displayed to provide an alphabetical list of all partner-providers or an alphabetical list of favorite providers for the shopper. The directory may also include information indicating whether a provider provides “quick checkout wallet.” The directory may include a search box for searching a provider using either a provider's name or a description keyword. The shopper may add a selected provider from the directory of providers to his or her favorite provider list.

The shopping information item 112 may provide a link to a shopping information page about providers of the products and service. When the shopper activates the shopping information item 112, a shopping information page “MENU OF PROVIDERS” may be displayed to provide an alphabetical list of “all providers,” which are partner-providers, and/or an alphabetical list of favorite providers for the shopper. The menu may include a search box for searching a provider using either a provider's name or a description keyword. The shopper may add a selected provider from the menu of providers to his or her favorite provider list.

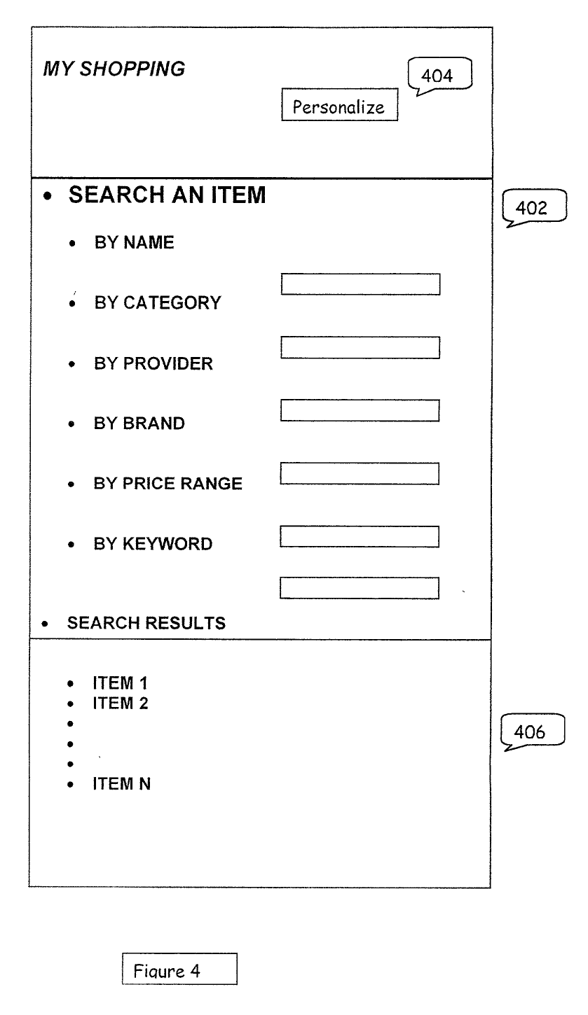

The shopping information item 114 may provide a shopping information page about searching a product or service. When the shopper activates the shopping information item 114, the exemplary shopping information page “SEARCH AN ITEM,” as shown in FIG. 4, may be displayed. The shopping information page may provide a search box for searching an item under “ALL PROVIDERS” OR “FAVORITE PROVIDERS.” The shopper may use the search section 402 to search an item based on the item's name, descriptive keyword, shopping category, brand name, or a price range. The shopper may personalize the shopping information page for searching an item by activating the “personalize” icon 404. The shopping information page in FIG. 4 may provide a list of items in a search result section 406. The shopper may select a provider for the searched item, and add it to his or her favorite provider list.

The shopping information item 116 may provide a link to a shopping information page about “SPECIAL PROMOTIONS”, which may include special sales running on products or service. Special promotions provided under this shopping information item may be the same special items that may be provided under the shopping information item 102. The special promotions information may be personalized for the shopper, providing special promotions tailored to the shopper's favorite shopping category or providers. The information item 116 may include a search box for searching an item based on the item's name, descriptive keyword, shopping category, or brand name. The shopper may select a provider from the list of items in the special promotion, and add it to his or her favorite provider list.

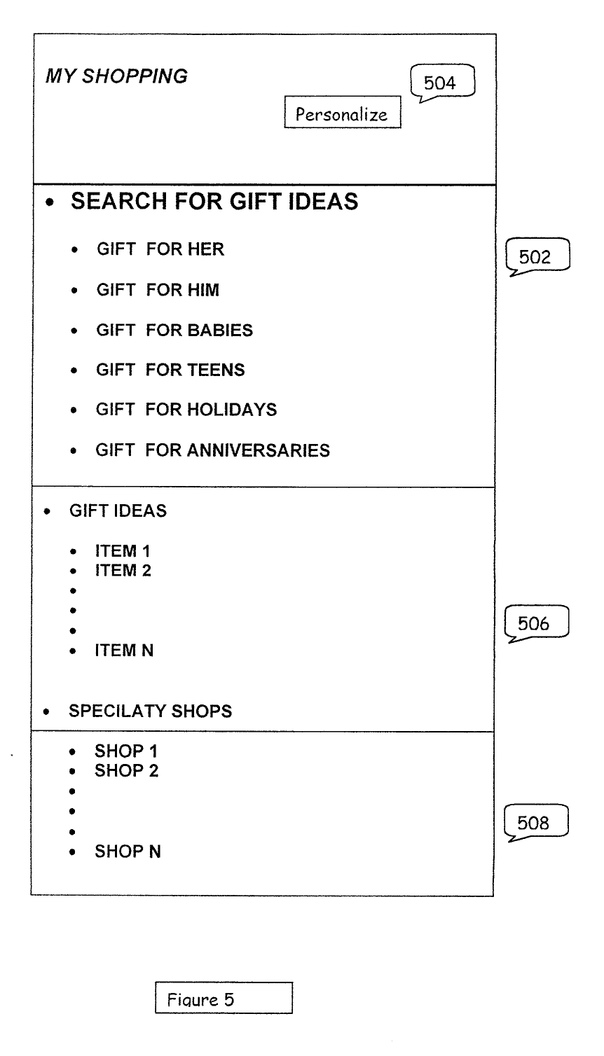

The shopping information item 118 may provide a shopping information page about gift ideas and specialty shops. When the shopper activates the shopping information item 118, the exemplary shopping information page, as shown in FIG. 5, may be displayed. The shopping information page in FIG. 5 may provide gift ideas for a forthcoming special occasion, for a holiday, for a charity, for another person on the shopper's shopping list, for her, for him, for teens, for a baby, and for a price range. The gift ideas search section 502 may include search boxes for searching gift ideas based on an occasion, a descriptive keyword, a shopping category, or a brand name. The shopper may personalize his search information by activating the “Personalize” icon 504. The shopping information section 506 provides a list of search ideas. The shopper may select a provider from the list of gift ideas, and may add it to his or her favorite provider list.

The shopping information page in FIG. 5 may provide information about “SPECIALTY SHOPS” 508 that may provide specialty shops for a special occasion, for a holiday, for a charity, for another person on the shopper's shopping list, for her, for him, for teens, and for a baby. The shopping information page in FIG. 5 may also include search boxes for searching specialty shops based on a specialty shop's name, a descriptive keyword, a shopping category, or a brand name. The shopper may select a provider from the list of specialty shops, and may add it to his or her favorite provider list.

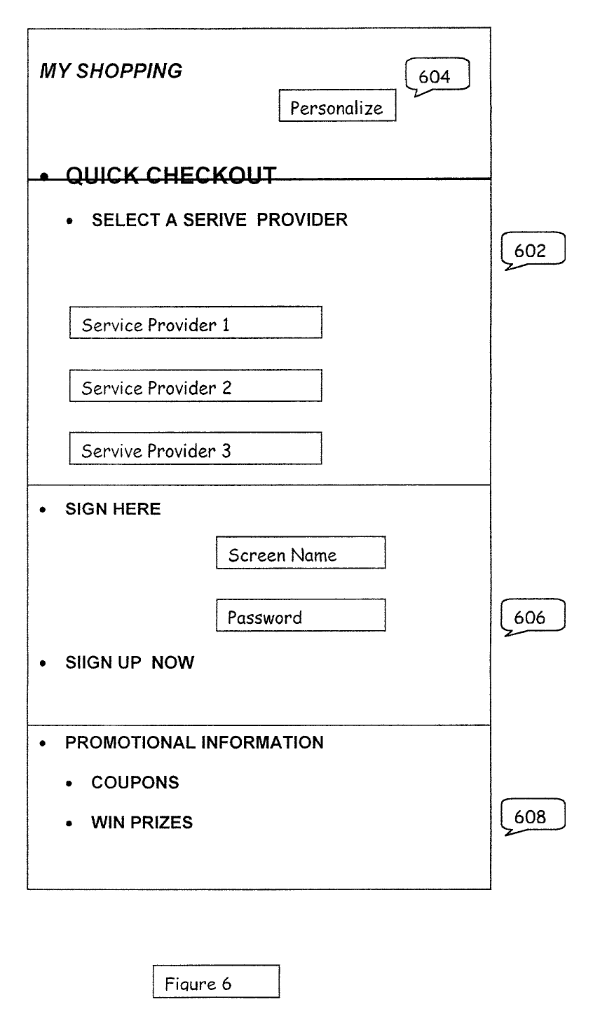

The shopping information item 120 may provide a shopping information page about quick checkout wallet service. When the shopper activates the shopping information item 120, an exemplary shopping information page “QUICK CHECKOUT,” as shown in FIG. 6, may provide information about how to purchase an item online. The quick checkout information page may provide a list 602 of affiliate online shopping service providers that the shopper may select and log onto to purchase an item on line. The shopper may need to enter his or her authentication information, such as a screen name and/or a password, to be able to purchase an item online. The quick checkout information page may provide promotional information, which may include coupons and/or prizes 608, to encourage the shopper to purchase online.

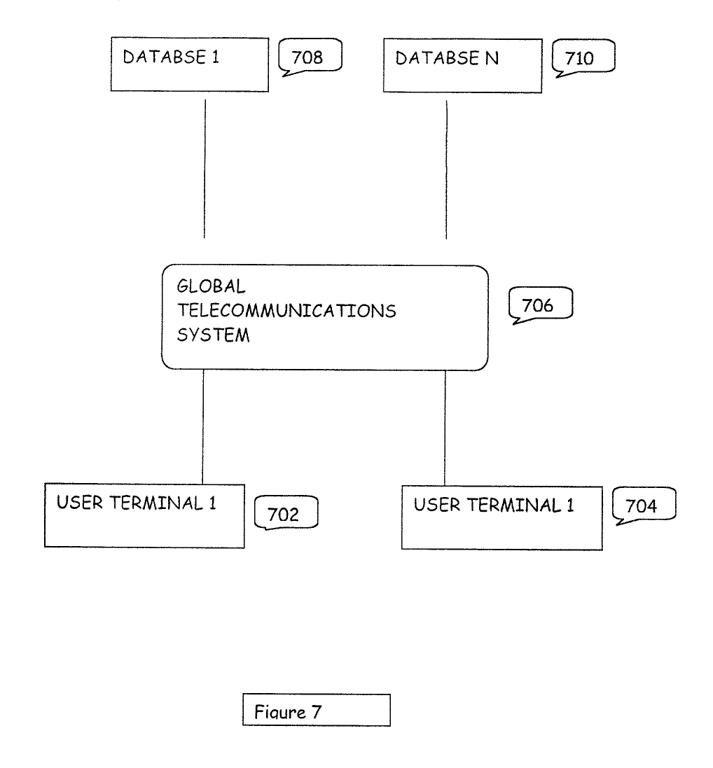

FIG. 7 shows a representation of an exemplary system for providing personalized shopping information according to one embodiment of the invention. The user terminals 702, 704 may include the hardware and software modules to implement the disclosed invention. The user terminals may also include the necessary devices and software modules to connect to the global telecommunication network 706, which may include the Internet. A shopper may use a user terminal to search for shopping information that may be warehoused in the databases 708, 710. The shopping service providers or system managers may regularly update the databases.

The method and system enclosed herein provides personalized, instant, comprehensive, and relevant online shopping information and assistance all in one shopping information page. The method and system enclosed herein also provides a customized and filtered comparison shopping experience that enables online shoppers to conveniently, and easily shop online confidently, knowing that they are getting their desired product and service from their favorite department stores or shops. The method and system of the present invention further provides access to the personalized shopping lists owned by the shopper as well as the shopping lists owned by other persons.

Thus, the system and method enclosed herein saves shopping time, attracts more physical retail outlet stores to join online shopping service providers, and retains the online product or service providers.

Accordingly, although the invention has been described in detail with reference to particular preferred or exemplary embodiments, persons possessing ordinary skill in the art to which this invention pertains will appreciate that various modifications and enhancements may be made without departing from the spirit and scope of the claims that follow.

1. A method for providing online personalized shopping information for a shopper, comprising the steps of:
providing personalized information about at least one favorite provider of an item, the personalized information including special-sale items and popular items provided by the at least one favorite provider; and
providing personalized collections of at least one favorite item, the personalized collections including a shopping list related to the shopper and a shopping list related to a person other than the shopper.

2. The method of claim 1, wherein the personalized shopping information is provided on a shopping Web page that is connected to an online shopping service provider's home page.

3. The method of claim 1, further including a change indicator for each shopping list.

4. The method of claim 1, further including a number of the at lest one favorite item in each shopping list.

5. The method of claim 1, further including:
providing a search box for searching each shopping list.

6. The method of claim 1, further including:
providing a directory of providers.

7. The method of claim 1, further including:
providing a search box for searching an item.

8. The method of claim 7, further including:
providing the search box for searching the item from the at least one favorite provider.

9. The method of claim 1, further including:
providing personalized information about special promotions.

10. The method of claim 1, further including:
providing a menu of providers.

11. The method of claim 1, further including:
providing information about at least one gift idea.

12. The method of claim 1, further including:
providing information about at least one specialty provider.

13. The method of claim 1, further including:
providing a link for quick checkout of an item.

14. A method for providing online personalized shopping information for a shopper, comprising the steps of:
providing personalized information about at least one favorite provider of an item; and
providing personalized information about a collection of at least one favorite item.

15. The method of claim 14, wherein the personalized shopping information is provided on a shopping Web page that is connected to an online shopping service provider's home page.

16. The method of claim 14, wherein the personalized information about the collection of at least one favorite item includes special-sale items from the at least one favorite provider.

17. The method of claim 14, wherein the personalized information about the collection of at least one favorite item includes popular items from the at least one favorite provider.

18. The method of claim 14, wherein the information about the collection of at least one favorite item includes information about a shopping list of at least one favorite item.

19. The method of claim 18, wherein the shopping list relates to the shopper.

20. The method of claim 19, wherein the information about the shopping list includes a change indicator for the shopping list.

21. The method of claim 19, wherein the information about the shopping list includes a number of the at lest one favorite item in the shopping list.

22. The method of claim 18, wherein the shopping list relates to a person other than the shopper.

23. The method of claim 22, wherein the information about the shopping list includes a change indicator for the shopping list.

24. The method of claim 22, wherein the information about the shopping list includes a number of the at lest one favorite item in the shopping list.

25. The method of claim 22, further including:
providing a search box for searching the shopping list.

26. The method of claim 14, further including:
providing a directory of providers.

27. The method of claim 14, further including:
providing a search box for searching an item.

28. The method of claim 27, further including:
providing the search box for searching the item from the at least one favorite provider.

29. The method of claim 14, further including:
providing personalized information about special promotions.

30. The method of claim 14, further including:
providing a menu of providers.

31. The method of claim 14, further including:
providing information about at least one gift idea.

32. The method of claim 14, further including:
providing information about at least one specialty provider.

33. The method of claim 14, further including:
providing a link for quick checkout of an item.

34. A method for providing online shopping information for a shopper, comprising the steps of:
searching at least one favorite shopping category for the shopper; and
providing information about at least one item in the at least one favorite shopping category.

35. The method of claim 34, further including personalizing the at least one shopping category.

36. The method of claim 35, wherein the personalizing step includes personalizing the at least one shopping category via a menu of shopping categories.

37. The method of claim 34, wherein the providing step includes providing information about at least one special-sale item in the at least one favorite shopping category.

38. The method of claim 34, wherein the providing step includes providing information about at least one popular item in the at least one favorite shopping category.

39. A method for providing online shopping information for a shopper, comprising the steps of:
searching at least one favorite provider for the shopper; and
providing information about at least one item provided by the at least one favorite provider.

40. The method of claim 39, further including personalizing the at least one provider.

41. The method of claim 40, wherein the personalizing step includes personalizing the at least one provider via a menu of providers.

42. The method of claim 39, wherein the providing step includes providing information about at least one special-sale item provided by the at least one favorite provider.

43. The method of claim 39, wherein the providing step includes providing information about at least one popular item provided by the at least one favorite provider.

44. A method for online shopping by a shopper, comprising the steps of:
selecting a personalized shopping list of at least one favorite item; and
providing information about at least one item in the personalized shopping list.

45. The method of claim 44, wherein the selecting step includes selecting a personalized shopping list that relates to the shopper.

46. The method of claim 44, wherein the selecting step includes selecting personalized shopping list that relates to a person other than the shopper.

47. The method of claim 46, wherein the selecting step includes searching for the personalized shopping list that relates to a person other than the shopper.

48. The method of claim 47, wherein the searching for the personalized shopping list that relates to a person other than the shopper includes searching by name.

49. The method of claim 47, wherein the searching for the personalized shopping list that relates to a person other than the shopper includes searching by screen name.

50. The method of claim 47, wherein the searching for the personalized shopping list that relates to a person other than the shopper includes searching by e-mail address.

51. The method of claim 44, wherein the providing step includes providing information about at least one provider for each item in the personalized shopping list.

52. The method of claim 44, wherein the providing step includes providing information about at least one favorite provider for each item in the personalized shopping list.

53. The method of claim 44, wherein the providing step includes providing information about at least one item in the personalized shopping list.

54. A computer readable medium embodying a method for providing online shopping information, the method comprising the steps of:
searching at least one favorite provider for the shopper; and
providing information about at least one item in the at least one favorite provider.

55. A system for providing online shopping assistance, comprising:
at least one user terminal;
at least one database containing information about providers of shopping items;
means for searching at least one favorite shopping category for the shopper;
means for searching at least one favorite provider for the shopper;
means for providing information about at least one item in the at least one shopping category; and
means for providing information about at least one item provided by the at least one favorite provider.

56. The computer system of claim 55, further implemented on a network environment.

57. The computer system of claim 56, wherein the network environment includes a global telecommunications network.
